(19) United States
(12) Patent Application Publication
(10) Pub. No.: US 2016/0188195 A1
(43) Pub. Date: Jun. 30, 2016

(54) CELLPHONE WITH PROJECTION CAPABILITY

(71) Applicant: Ieon C. Chen, Laguna Hills, CA (US)

(72) Inventor: Ieon C. Chen, Laguna Hills, CA (US)

(73) Assignee: INNOVA ELECTRONICS, INC., Irvine, CA (US)

(21) Appl. No.: 14/586,717

(22) Filed: Dec. 30, 2014

(51) Int. Cl. G06F 3/0488; G06F 3/0484; G06T 5/00; H04M 1/02; H04N 9/31

(52) U.S. Cl. CPC G06F 3/04883; H04M 1/0266; H04N 9/3185; G06T 5/006; G06F 3/04842

(57) ABSTRACT

A method of adjusting an image projected by a projector in operative communication with a smartphone having a touch screen display, wherein the method includes projecting an image onto an adjacent surface using the projector and generating an image adjustment user interface on the touch screen display. The image adjustment user interface defines an image adjustment field on the touch screen display. The method further includes detecting a single finger gesture made by a user within the image adjustment field on the touch screen display and generating an image adjustment signal corresponding to the detected signal finger gesture. The projected image is then adjusted in accordance with the image adjustment signal.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field of the Invention

The present invention relates generally to smartphone projectors, and more specifically, to a smartphone-based system which enables a user to quickly and easily adjust an image projected from the smartphone using simple figure gestures on the smartphone touch screen display.

2. Description of the Related Art

Viewing digital content is an everyday occurrence for most people in today's society. The development and proliferation of smartphones and tablet computers, coupled with the development of high speed wireless transmission of digital content, such as through WiFi or mobile phone platforms, has made it much easier to access and view digital content almost anywhere in the world.

A wide range of digital content may be “consumed” or viewed on a smartphone. For instance, an individual may view photos/videos captured by the smartphone or sent from a friend or relative. Furthermore, a smartphone may be used to stream movies or shows on services such as NETFLIX™. Along those lines, a subscriber may be able to watch content from their TV cable provider on their smartphone/tablet. As such, there is an abundance of digital content available for display on a smartphone.

Most smartphones include a touch screen display on which the digital content is displayed, with the smartphones also having a form factor which allows easy transport and handling throughout the course of a day. For instance, most smartphones are sized to fit within a pocket or purse of a user. Due to the small form factor of most smartphones, the display screen on most smartphones is also fairly small. Although in recent years, there has been a trend to increase the size of the display screen, the size of the smartphone remains small enough to enable easy transport thereof. As such, the smartphone screen does not provide a particularly desirable viewing experience.

In view of the shortcomings of conventional smartphone displays, recent advancements in smartphone technology has resulted in the integration of projection capabilities into the smartphone. The projection capabilities allow the smartphone to project digital content onto an adjacent surface, such as a wall, screen or the like. In this regard, the projected image is much larger than the size of the smartphone display, which may provide a better viewing experience, as well as making it easier to share the digital content for viewing by a group of people.

Although the display of digital content through a smartphone projector provides certain advantages over the display of digital content on a conventional smartphone display, there are also drawbacks associated with conventional smartphone projector technology. For instance, conventional smartphone projector technology is severally limited with regard to the ability to adjustment the projected image. Thus, when the image is projected on a wall, the only recourse for changing the position and size of the image may be to move the smartphone itself, which may be impractical, depending on the environment, e.g., the room may be small or there may be an obstacle which prevents such movement. Furthermore, the size of the projected image may be dependent on the distance at which the smartphone is spaced from the wall, e.g., the image becomes smaller as the smartphone is moved closer to the wall, and larger as the image is moved away from the wall.

Accordingly, there is a need in the art for a system which enhances the ability of the user to adjust the characteristics of an image projected from a smartphone. Various aspects of the present invention are directed toward addressing this need, as will be described in more detail below.

### BRIEF SUMMARY

Various aspects of the present invention are directed toward a smartphone-based system and related method for adjusting a projected image using simple hand gestures on the smartphone's touch screen display. For instance, the user may be able to control the position and/or size of the projected image by swiping a single finger on the touch screen display. As such, the image may be adjusted in a manner which does not require movement of the smartphone itself.

According to one embodiment, there is provided a method of adjusting an image projected by a projector in operative communication with a smartphone having a touch screen display. The method includes projecting an image onto an adjacent surface using the projector and generating an image adjustment user interface on the touch screen display, wherein the image adjustment user interface defines an image adjustment field on the touch screen display. The method further includes detecting a single finger gesture made by a user within the image adjustment field on the touch screen display and generating an image adjustment signal corresponding to the detected signal finger gesture. The projected image is then adjusted in accordance with the image adjustment signal.

The step of detecting the single finger gesture may include detecting one of a first finger gesture in a first axial direction to adjust image height and a second finger gesture in a second axial direction perpendicular to the first axial direction to adjust image width.

The adjusting step may include adjusting the position of the projected image on the adjacent surface. The adjusting step may include adjusting the shape of the projected image.

The method may additionally include the step of focusing the projected image automatically independent of receiving user input. The method may further comprise the step of correcting image distortion automatically independent of receiving user input. The step of correcting image distortion may include making a keystone correction.

According to another embodiment, there is provided an image adjustment system adapted for use with a smartphone having a touch screen display adapted to detect a single finger gesture made on the smartphone, wherein the smartphone is in operative communication with a projector adapted to project an image onto an adjacent surface. The image adjustment system includes a user interface module in operative communication with the touch screen display and adapted to generate an image adjustment user interface including an image adjustment field on the touch screen display. A gesture detection module is in operative communication with the user interface module, with the gesture detection module being configured to convert a detected single finger gesture on the touch screen display into an image adjustment command for adjusting at least one of size, distortion, and position of the projected image. A projection module is in communication with the gesture detection module and the projector, with the projection module being adapted to configure the projector to adjust the projected image in accordance with the image adjustment command.

The image adjustment user interface may be capable of detecting a first finger gesture in a first axial direction to adjust image height, and a second finger gesture in a second axial direction perpendicular to the first axial direction to adjust image width. The image adjustment user interface may include an auto focus adjustment field, a manual focus adjustment field, a position adjustment field and a scale adjustment field.

The projection module may be adapted to adjust a position of the projected image on the adjacent surface. The projection module may be adapted to adjust a size of the projected image on the adjacent surface.

The system may further comprise an auto focus module in communication with the projector and adapted to focus the projected image on the adjacent surface independent of user input. The system may additionally include a distortion correct module in communication with the projector and adapted to correct distortion of the projected image on the adjacent surface independent of user input. The distortion correction module may be capable of performing a keystone correction on the projected image.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a smartphone projecting an image onto an adjacent surface;

FIG. 2 is a schematic diagram of a smartphone and a corresponding smartphone application for configuring the smartphone to facilitate user adjustment of a projected image;

FIG. 3 is a flow chart of an exemplary process of adjusting a projected image using the smartphone and the related smartphone application;

FIG. 4 is an exemplary depiction of a user interface on a smartphone having an integrated projector;

FIG. 5 is an exemplary depiction of a user interface on a smartphone having a detachably engageable projector.

FIG. 6 is a side view of the smartphone projecting an image onto an adjacent surface;

FIG. 7 is a front view of a projected image having a keystone distortion; and

FIG. 8 is a front view of a projected image wherein the size of the image is adjustable.

### DETAILED DESCRIPTION

The detailed description set forth below in connection with the appended drawings is intended as a description of certain embodiments of a smartphone image adjusting system and method and is not intended to represent the only forms that may be developed or utilized. The description sets forth the various structures and/or functions in connection with the illustrated embodiments, but it is to be understood, however, that the same or equivalent structures and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings wherein the showings are for purposes of illustrating a preferred embodiment of the present invention only, and not for purposes of limiting the same, there is depicted a smartphone-based system of projecting an image 10 onto an adjacent surface 12, as well as adjusting the projected image 10 to enhance the overall quality of the image 10 for more optimal viewing. Various aspects of the invention are directed toward configuring the smartphone 14 to allow a user to adjust the projected image 10 using a single finger, such as by swiping a finger in a first direction along a touch screen display 16 to increase the size of the projected image 10, and swiping a finger in a second direction to decrease the size of the projected image 10. In this respect, the projected image 10 may be adjusted without moving the smartphone 14.

As used herein, the word “smartphone” 14 refers broadly to a handheld electronic device capable of making and receiving telephone calls, as well as performing one or more functions of a computer. Furthermore, although the exemplary embodiment of the present invention includes a smartphone, it is also understood that the present invention may also apply to tablet computers, smart watches, or other electronic devices having a projector which currently exist, or which may be later developed.

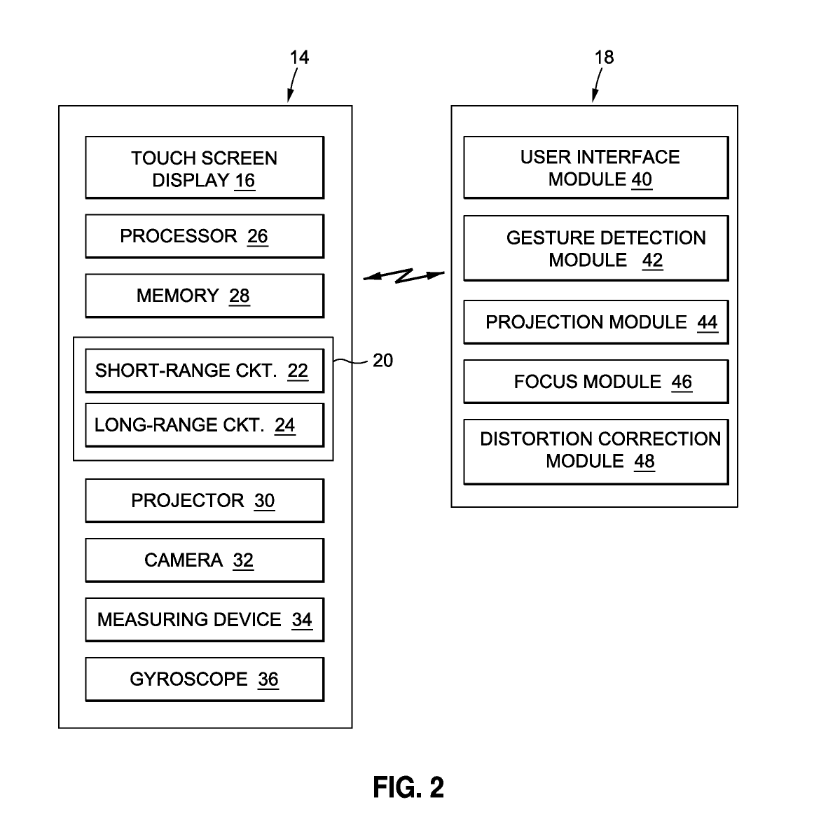

Referring now to FIG. 2, there is depicted a schematic diagram of a smartphone 14, and a related smartphone application 18 (i.e., “app.”) which may be downloaded onto the smartphone 14. The communication capability of the smartphone 14 is facilitated through a communications circuit 20, which may include a short-range communications circuit 22 capable of short-range communications (e.g., BLUETOOTH™, WiFi, etc.) as well as a long-range communications circuit 24 capable of long-range communications (e.g., communications over a cellular telephone network). To enable such computational functionality, a smartphone 14 includes an onboard processor 26 and memory unit 28. The smartphone 14 may additionally include other hardware to enhance the overall functionality thereof, including but not limited to the touchscreen display 16, a projector 30, a camera 32, a measuring device 34 (for measuring the distance between the smartphone 14 and the adjacent surface 12), and a gyroscope 36, as will be described in more detail below. It is understood that the projector 30 may be integrated into the smartphone 14 or alternatively, the smartphone 14 may include a port 38 (e.g., auxiliary port or USB port) which is adapted to be connectable to a projector.

The smartphone projector 30 may be used to project an image, video, slideshow presentation or any other media commonly projected by a projecting device onto an adjacent surface 12, such as a wall, door, window, screen, etc. . . . The term “projected image” 10 will be used herein to broadly refer to anything projected by the projector 30, and will not be limited to still images. The smartphone projector 30 may project image(s) associated with digital files stored locally on the smartphone 14, or digital files stored remotely from the smartphone 14, such as files stored on a memory disk, a remote computer or server, or files streamed over the Internet or other network. The projector 30 may have the ability to selectively move the axis along which the image is projected therefrom, so as to enable adjustment of the projected image in both vertical and horizontal directions, as will be described in more detail below. In this respect, the projector 30 may include a motor which moves the lamp or minors for selectively adjusting the position of the projected image.

According to one embodiment, the present invention includes a smartphone application (i.e., “app”) 18 that is downloadable onto the smartphone 14 to configure the smartphone 14 to enable a user to make simple gestures on the touch screen display 16 for adjusting the projected image 10. For instance, the user may want to move the image 10 up, down, left or right. The user may also want to adjust the size of the image 10 by making the image bigger or smaller. Other adjustments which the user may want to make include bringing the image 10 into focus and correcting any image distortion.

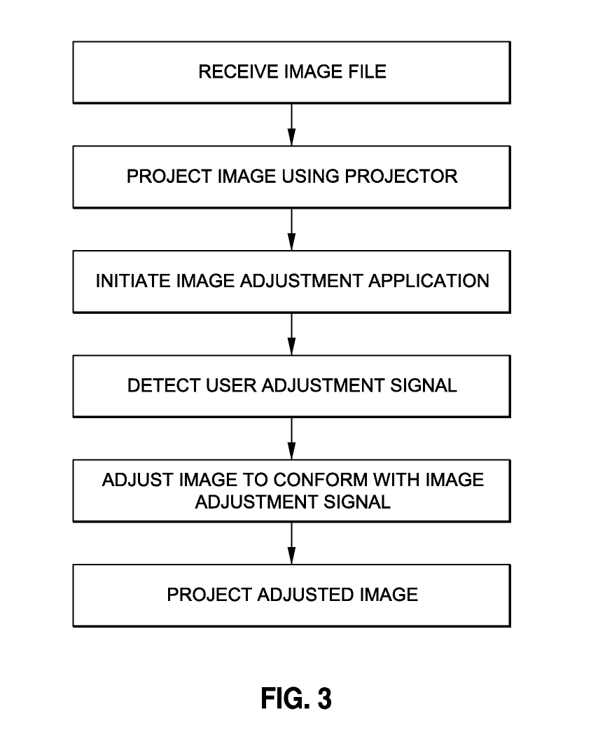

FIG. 3 depicts a flowchart summarizing the process performed by the image adjustment system. In general, the process includes receiving the digital file associated with the image 10 and projecting the image 10 onto an adjacent surface 12 using the projector 30 operatively coupled to the smartphone 14. The process further includes initiating an image adjustment application 18 on the smartphone 14 and displaying an image adjustment user interface on the touch screen display 16. The user then makes simple finger gestures on the image adjustment user interface, preferably using only a single finger, to enter an adjustment command, which is then translated by the smartphone 14 into a digital adjustment signal. The smartphone 14 adjusts the image 10 to conform with the adjustment signal, and then projects the adjusted image 10 onto the surface 12.

Referring back to FIG. 2, the smartphone application 18 includes a plurality of modules which may be downloaded onto the smartphone 14 and stored on the smartphone's local memory 28. The various modules are adapted to interface with the smartphone's hardware for configuring the smartphone 14 to perform portions of the process described above. In this respect, the steps of receiving the image file and projecting the raw image in most cases can be performed without the smartphone app 18. As such, the smartphone app. 18 is focused on refining the projected image 10 to achieve optimal viewing results.

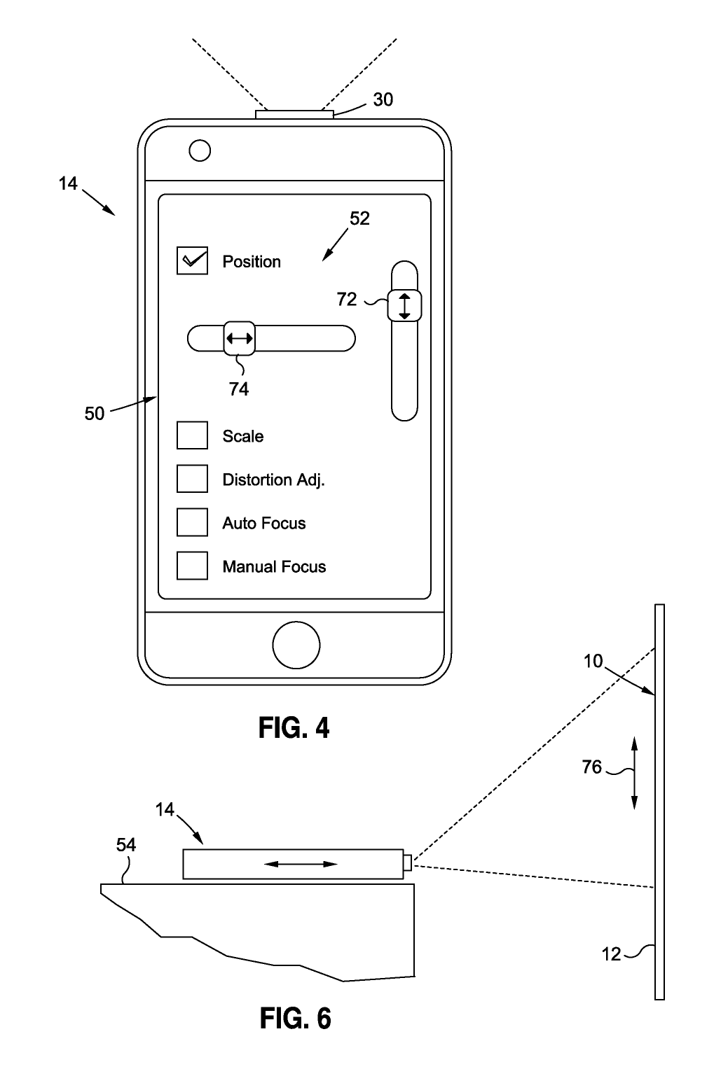

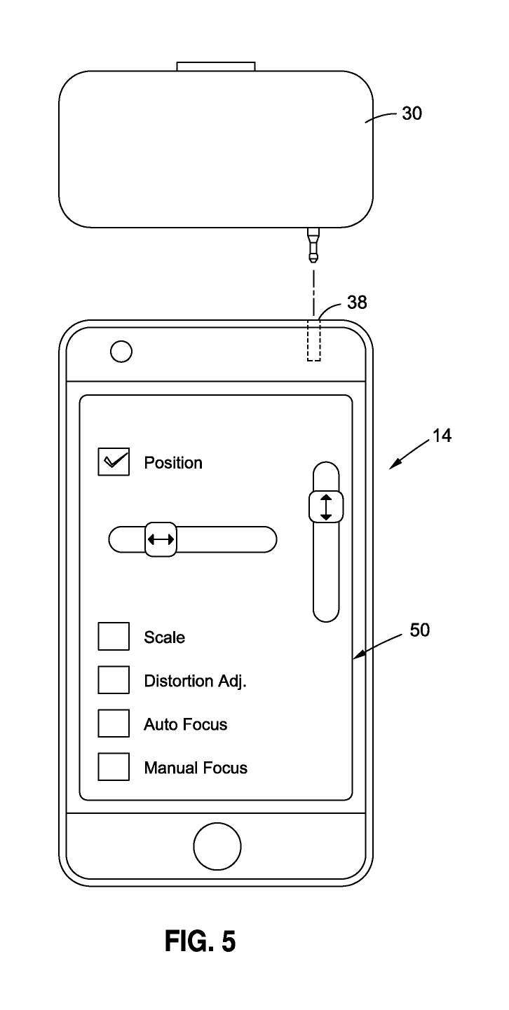

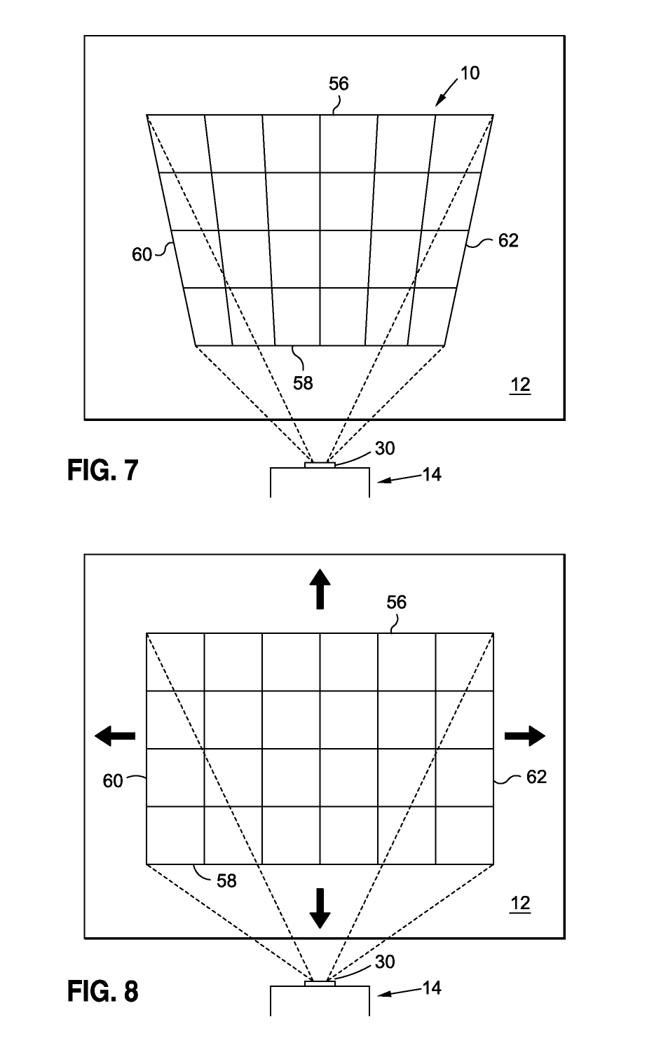

The smartphone application 18 may include a user interface module 40, a gesture detection module 42, a projection module 44, a focus module 46, and a distortion correction module 48. The user interface module 40 is adapted to generate the image adjustment user interface 50 on the smartphone touch screen display 16 to allow the user to selectively adjust the projected image 10. FIG. 4 shows an exemplary image adjustment user interface 50 having a plurality of selectable options for adjusting the projected image 10. In particular, the user interface 50 includes an Auto Focus Adjustment option, a Manual Focus Adjustment option, a Position adjustment option, and a Scale adjustment option. Each option includes a box which can be selected by a user, with the user simply touching the box on the touch screen display to make such selection. The user interface module 40 is in communication with the processor 26 and touch screen display 16 on the smartphone 14 to generate the image adjustment user interface 50 thereon.

The image adjustment user interface 50 is preferably arranged in a manner which allows the user to easily adjust the projected image 10 using very simple hand or finger gestures. Along these lines, the image adjustment user interface 50 preferably defines an image adjustment field 52 on the touch screen display 16, wherein the user can simply swipe a single finger in a prescribed direction to make a particular adjustment to the image. For instance, the image adjustment field 52 may allow for image width adjustment by swiping the user's finger along a first axis, wherein swiping the finger in a first direction along the first axis causes the image width to increase, and swiping the finger in an opposing second direction along the first axis causes the image width to decrease.

The gesture detection module 42 is in operative communication with the user interface module 40 as well as the touch screen sensors and is configured to convert a detected finger gesture on the touch screen display 16 into an image adjustment command for adjusting the projected image 10.

The projection module 44 is in communication with the gesture detection module 42 and the projector 30, with the projection module 44 being adapted to configure the projector 30 to adjust the projected image 10 in accordance with the image adjustment command received from the gesture detection module 42.

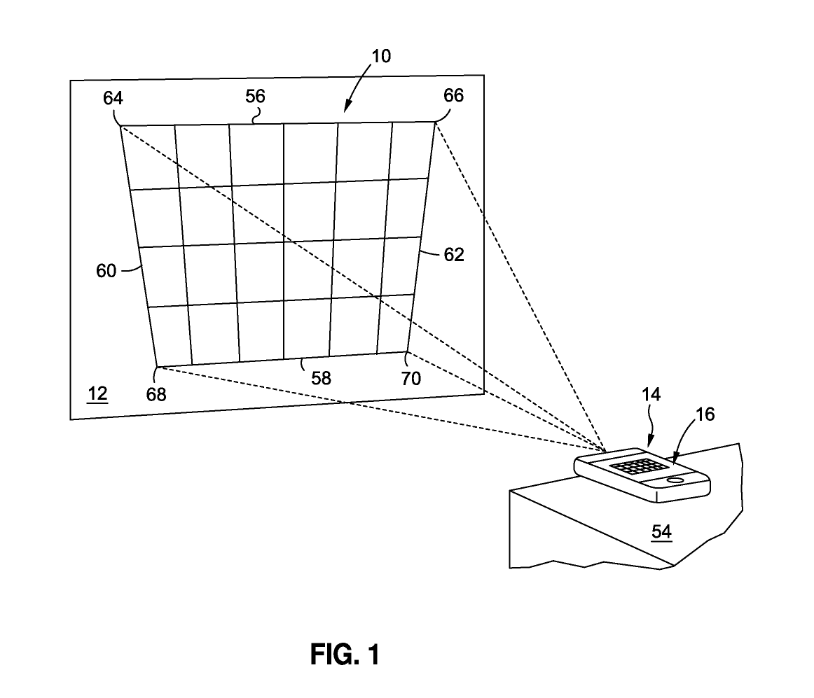

Referring now to FIGS. 1 and 6, there is depicted a smartphone 14 resting on an underlying support surface 54, such as a desk, counter, table, etc., and projecting an image 10 onto an adjacent surface 12. The image 10 defines an image boundary, which in many cases is rectangular in shape, and thus, defines an upper edge 56, a lower edge 58, and a first side edge 60, and a second side edge 62. The upper edge 56 intersects the first side edge 60 at a first upper coordinate 64 and the second side edge 62 at a second upper coordinate 66. Likewise, the lower edge 58 intersects the first side edge 60 at a first lower coordinate 68 and the second side edge 62 at a second lower coordinate 70. The upper edge 56 defines an upper width as the distance between the first and second upper coordinates 64, 66, the lower edge 58 defines a lower width as the distance between the first and second lower coordinates 68, 70, the first side edge 60 defines a first side height as the distance between the first upper coordinate 64 and the first lower coordinate 68, and the second side edge 62 defines a second side height as the distance between the second upper coordinate 66 and the second lower coordinate 70.

In one mode of operation, the position of the image 10 may be adjusted. When the position is adjusted, the size and shape of the image 10 may be maintained. To access the position adjustment mode, the user selects the “Position” option listed on the image adjustment user interface 50 by selecting the box next to “Position.” The image adjustment field 52 is then displayed on the touch screen display 16 and the user makes a gesture(s) within the image adjustment field 52 until the image 10 is positioned on the adjacent surface 12 in the desired position. In one implementation, the image adjustment field 52 includes a vertical axis 72, wherein the user slides a finger in a first vertical direction (e.g., up) to move the projected image 10 up, and a second vertical direction (e.g., down) to move the projected image down. FIG. 6 is a side view of the smartphone 14 resting on the support surface 54, wherein the arrow 76 represents the ability of the image 10 to be moved in a vertical direction Likewise, the image adjustment field 52 also includes a horizontal axis 74 to allow the user to adjust the image 10 in a horizontal direction, with the user sliding the finger in a first horizontal direction (e.g., left) to move the projected image 10 to the left, and a second horizontal direction (e.g., right) to move the projected image 10 to the right. In another implementation, the image adjustment field 52 may allow for more free-form adjustment of the image 10, wherein the user can trace the finger within the image adjustment field 52 in any direction to make a corresponding adjustment to the image 10. Such free-form adjustment is similar to a user controlling a computer mouse using a touchpad, which is a technique employed by many laptop computers.

In another operational mode, the scale or size of the image 10 can be adjusted. To access the scale/size adjustment mode, the user selects the “Scale” option on the image adjustment user interface 50. When the Scale option is selected, an image adjustment field 52 is defined on the touch screen display 16 which allows the user to selectively adjust the size of the projected image 10. In one embodiment, the image adjustment field 52 may be similar to the image adjustment field 52 described above in relation to the position adjustment. In this respect, the size adjustment may include a first adjustment axis which corresponds to adjustment of the image width, and a second adjustment axis which corresponds to adjustment of image height. As such, when a user swipes a finger along the first adjustment axis in a first direction, the width increases, and when a finger is swiped in a second direction, the width decreases. Similarly, when a user swipes a finger along the second adjustment axis in a first direction, the height increases, and when a finger is swiped in a second direction, the height decreases.

While the foregoing describes making single finger gestures on a touch screen display 16 of the smartphone 14, it is expressly contemplated that other embodiments may allow a user to make “virtual” gestures which are detected by the smartphone 14. In this respect, the user may not be required to interface directly with the smartphone 14, and instead, may make gestures in space, on a surface next to the smartphone 14, such as a table, desk, counter, or the like. An example of such virtual detection is shown in U.S. Pat. No. 8,831,814 entitled Electronic Device with Virtual Display and Input, the contents of which are expressly incorporated herein by reference. In such an embodiment, the smartphone 14 may include an input (gesture) detection sensor for detecting gestures made by the user, with such gestures being treated in a similar manner to the gestures made directly on the touch screen display 16, as described in more detail above. In some cases, the smartphone 14 may be capable of detecting gestures made on or near the projected image 10, such that a user may make the same gestures on the projected image 10 as the user would make to adjust the image if it were displayed on the touch screen display 16. For instance, the user may “pinch” the projected image 10 to make it smaller, or “spread” the projected image 10 to make it larger. Alternatively, the user may move a hand or finger along a first axis (e.g., a vertical axis) for adjusting the height of the image 10, or the user may move a hand or finger along a second axis (e.g., a horizontal axis) for adjusting the width of the image 10.

In addition to manual adjustment of the position and size of the projected image 10, various embodiments of the smartphone application 18 may include the ability to make one or more automatic adjustments of the projected image 10. Such automatic adjustments may include automatic focusing of the projected image 10 on the projected surface 12, as well as automatic keystone correction of the image. To that end, one embodiment of the smartphone application 18 includes a focus module 46 in communication with the projector 30 and adapted to focus the projected image 10 on the adjacent surface 12 independent of user input. The focus module 46 may employ known image focusing techniques to automatically correct the projected image 10. One exemplary technique is described in U.S. Patent Application Publication No. 2011/0181841, entitled Autofocus Image Projection Apparatus, the contents of which are expressly incorporated herein by reference.

According to one embodiment, the automatic focusing functionality is actuated when the user selects the Auto Focus Adjustment option on the image adjustment user interface 50. Such a selection actuates the focus module 46 for automatically focusing the image 10 on the projected surface 12 using the pre-programmed algorithms.

Although the foregoing describes automatic focus adjustment, it is also contemplated that the smartphone application 18 may enable manual focus adjustment. In this respect, the user interface 50 may display one or more manual focus controls or slides to enable the user to make incremental focus adjustment of the projected image 10.

According to another aspect of the invention, the smartphone application 18 includes a distortion correction module 48 in communication with the projector 30 and adapted to correct distortion of the projected image 10 on the adjacent surface 12 independent of user input. It is understood that unless the projector 30 is carefully aligned with the projection surface 12, the resulting projected image 10 may appear distorted, or “keystoned.” The term “keystone” as used herein may refer broadly to any distortion caused by misalignment in projector position or orientation, including trapezoidal distortion caused by projector pitch misalignment. When a “keystone correction” is made, the projected image is adjusted from its trapezoidal configuration to a more rectangular configuration. One exemplary technique of making a keystone correction is described in U.S. Pat. No. 6,753,907, entitled Method and Apparatus for Automatic Keystone Correction, the contents of which are expressly incorporated herein by reference.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A set of computer executable instructions capable of being downloaded onto a smartphone having a touch screen display and a projector in operative communication with the smartphone, the set of computer executable instructions being capable of configuring the smartphone to:
send a signal to the projector for projecting an image onto an adjacent surface;
generate an image adjustment user interface on the touch screen display, the image adjustment user interface defining an image adjustment field on the touch screen display;
detect a single finger gesture made by a user within the image adjustment field on the touch screen display;
generate an image adjustment signal corresponding to the detected signal finger gesture; and
adjust the projected image in accordance with the image adjustment signal.

2. The set of computer executable instructions recited in claim 1, wherein the projected image defines an image height and an image width, wherein the step of detecting the single finger gesture includes detecting one of:
a first finger gesture in a first axial direction to adjust image height; and
a second finger gesture in a second axial direction perpendicular to the first axial direction to adjust image width.

3. A method of adjusting an image projected by a projector in operative communication with a smartphone having a touch screen display, the method comprising the steps of:
projecting an image onto an adjacent surface using the projector;
generating an image adjustment user interface on the touch screen display, the image adjustment user interface defining an image adjustment field on the touch screen display;
detecting a single finger gesture made by a user within the image adjustment field on the touch screen display;
generating an image adjustment signal corresponding to the detected signal finger gesture; and
adjusting the projected image in accordance with the image adjustment signal.

4. The method recited in claim 3, wherein the projected image defines an image height and an image width, wherein the step of detecting the single finger gesture includes detecting one of:
a first finger gesture in a first axial direction to adjust image height; and
a second finger gesture in a second axial direction perpendicular to the first axial direction to adjust image width.

5. The method recited in claim 3, wherein the adjusting step includes adjusting the position of the projected image on the adjacent surface.

6. The method recited in claim 3, further comprising the step of focusing the projected image automatically independent of receiving user input.

7. The method recited in claim 3, further comprising the step of correcting image distortion automatically independent of receiving user input.

8. The method recited in claim 7, wherein the step of correcting image distortion includes making a keystone correction.

9. The method recited in claim 3, wherein the adjusting step includes adjusting the shape of the projected image.

10. An image adjustment system adapted for use with a smartphone having a touch screen display adapted to detect a single finger gesture made on the smartphone, the smartphone being in operative communication with a projector adapted to project an image onto an adjacent surface, the image adjustment system comprising:
a user interface module in operative communication with the touch screen display and adapted to generate an image adjustment user interface including an image adjustment field on the touch screen display;
a gesture detection module in operative communication with the user interface module, the gesture detection module being configured to convert a detected single finger gesture on the touch screen display into an image adjustment command for adjusting at least one of size, distortion, and position of the projected image; and
a projection module in communication with the gesture detection module and the projector, the projection module being adapted to configure the projector to adjust the projected image in accordance with the image adjustment command.

11. The system recited in claim 10, wherein the image adjustment user interface is capable of detecting:
a first finger gesture in a first axial direction to adjust image height; and
a second finger gesture in a second axial direction perpendicular to the first axial direction to adjust image width.

12. The system recited in claim 10, wherein the image adjustment user interface includes an auto focus adjustment field, a manual focus adjustment field, a position adjustment field and a scale adjustment field.

13. The system recited in claim 10, wherein the projection module is adapted to adjust a position of the projected image on the adjacent surface.

14. The system recited in claim 10, wherein the projection module is adapted to adjust a size of the projected image on the adjacent surface.

15. The system recited in claim 10, further comprising an auto focus module in communication with the projector and adapted to focus the projected image on the adjacent surface independent of user input.

16. The system recited in claim 10, further comprising a distortion correct module in communication with the projector and adapted to correct distortion of the projected image on the adjacent surface independent of user input.

17. The system recited in claim 16, wherein the distortion correction module is capable of performing a keystone correction on the projected image.

18. A system for adjusting a projected image, the system comprising:
a projector in operative communication with the smartphone and adapted to project an image onto an adjacent surface;
a smartphone in operative communication with the projector, the smartphone having:
a touch screen display;
a user interface module in operative communication with the touch screen display and adapted to generate an image adjustment user interface including an image adjustment field on the touch screen display;
a gesture detection module in operative communication with the user interface module, the gesture detection module being configured to convert a detected single finger gesture on the touch screen display into an image adjustment command for adjusting at least one of size, distortion, and position of the projected image; and
a projection module in communication with the gesture detection module and the projector, the projection module being adapted to configure the projector to adjust the projected image in accordance with the image adjustment command.

19. The system recited in claim 18, wherein the projector is integrated into the smartphone.

20. The system recited in claim 18, wherein the projector is detachably engageable with the smartphone.

21. The system recited in claim 18, wherein the image adjustment user interface is capable of detecting:
a first finger gesture in a first axial direction to adjust image height; and
a second finger gesture in a second axial direction perpendicular to the first axial direction to adjust image width.

22. The system recited in claim 18, further comprising a distortion correct module in communication with the projector and adapted to correct distortion of the projected image on the adjacent surface independent of user input.
